(19) United States
(12) Patent Application Publication
(10) Pub. No.: US 2014/0061117 A1
(43) Pub. Date: Mar. 6, 2014

(54) WATER FILTER WITH MULTIPLE INTERNAL FILTRATION MODULES

(71) Applicant: AQUA IP, Auburn, WA (US)

(72) Inventors: Scott Borough, Renton, WA (US); Larry Meek, Renton, WA (US); Laren Meek, Renton, WA (US)

(73) Assignee: AQUA IP, Auburn, WA (US)

(21) Appl. No.: 13/868,713

(22) Filed: Apr. 23, 2013

Related U.S. Application Data
(60) Provisional application No. 61/636,990, filed on Apr. 23, 2012.

(51) Int. Cl. B01D 29/58

(52) U.S. Cl. CPC B01D 29/58
USPC 210/337; 210/335

(57) ABSTRACT

The current application is directed to canister-type water filters that include at least two different types of filter media contained within at least two internal modules. The canister-type water filters to which the current application is directed provide the cost-effectiveness, ease of maintenance, and robustness of currently available canister-style water filters, but provide effective removal of a far broader range of contaminants than currently available canister-style water filters.

### CROSS-REFERENCE TO RELATED APPLICATION

This application claims the benefit of Provisional Application No.61/636.994, filed Apr. 23, 2012.

### TECHNICAL FIELD

The current application is directed to canister-type water filters and, in particular, to a canister-type water filter that includes several different types of internal filtration modules.

### BACKGROUND

Canister-style water filters are commonly used to filter water supplied by public water utilities prior to distribution of the water within internal water-supply lines of residential buildings and commercial buildings, and may also be used in the treatment of private well water and other water sources. Often, canister-style water filters employ a single type of filtration medium, such as granular activated carbon (“GAC”) or polymeric filters. While each particular type of filter currently employed in canister-type water filters may be effective for removing particular types of contaminants, no single type of filter medium is effective across the broad range of contaminants that may be present in water supplied by public water utilities and private wells, including various types of metal ions and metal particulates, microbial contaminants, chlorine, volatile organic compounds, pesticides, industrial chemical contaminants, and many other types of contaminants. Canister-type water filters are, however, relatively inexpensive and easy to maintain. Building owners and residential-housing-unit occupants therefore seek water filters with the ease of maintenance, cost effectiveness, and durability of canister-type water filters but with broader and more effective contaminant-removal capabilities.

### SUMMARY

The current application is directed to canister-type water filters that include at least two different types of filter media contained within at least two internal modules. The canister-type water filters to which the current application is directed provide the cost-effectiveness, ease of maintenance, and robustness of currently available canister-style water filters, but provide effective removal of a far broader range of contaminants than currently available canister-style water filters.

### BRIEF DESCRIPTION OF THE DRAWINGS

FIG. 1 provides a diagram of an example multiple-filter-media canister-style water filter to which the current application is directed.

FIG. 2 shows the example multi-figure-media canister-style water filter shown in FIG. 1 in cross-section.

FIG. 3 shows the first internal filtration module of an example multi-filter-media canister-type water filter to which the current application is directed.

FIG. 4 provides an exploded view of the first internal filtration module shown in FIG. 3.

FIG. 5 illustrates an exploded view of the second internal filtration module of an example multi-filter-media canister-type water filter to which the current application is directed.

### DETAILED DESCRIPTION

The current application is directed to canister-style water filters that include at least two different types of filter media included within at least two different internal modules within the canister-style water filters. Use of multiple types of filter media within multiple internal modules preserves the ease use of maintenance, robustness, and cost-effectiveness of canister-style water filters but provides efficient removal of a much broader range of contaminants and undesirable particulate and chemical substances than currently available canister-style water filters.

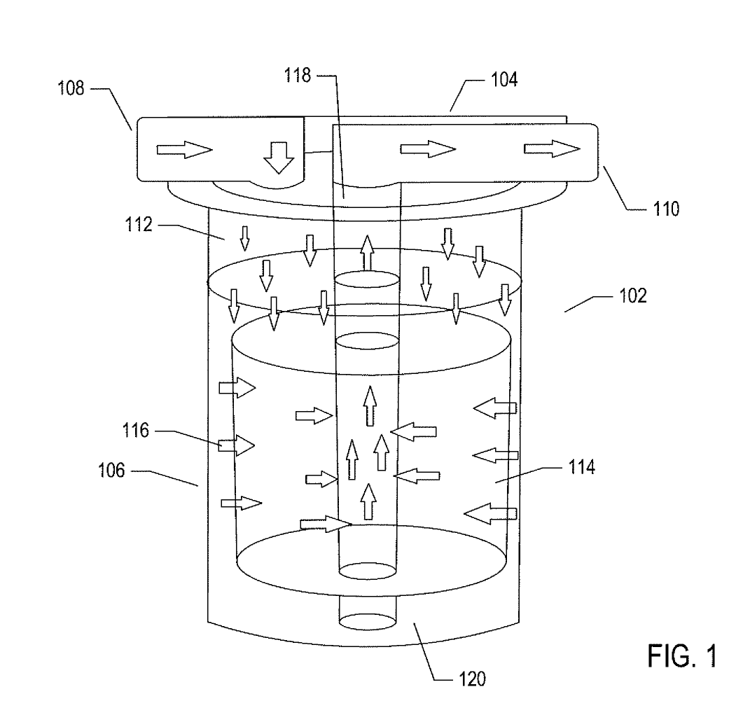

FIG. 1 provides a diagram of an example multiple-filter-media canister-style water filter to which the current application is directed. The canister is a robust, thick, durable plastic housing 102 that includes a headpiece 104 into a threaded receptacle of which the canister portion 106 of the plastic housing screws. A a tight compression fitting provided by the threaded mating of the canister 106 and the head portion 104 produces a water-tight seal, which may be supplemented, in certain examples, by an O-ring or gasket. Source water enters the canister-style water filter through threaded input pipe 108, a molded component of the head unit 104, and filtered water leaves the canister-type filter through threaded output port 110, also a molded component of the head unit. The input water passes through a first cylindrical filtration module 112 and then into a cylindrical space enclosed by the canister housing 106 and the surface of a second filtration module 114 from which the water that is passed through the first cylindrical filtration module enters a second filtration module 114 in the radial directions indicated by horizontal arrows, such as arrow 116. The second filtration module includes a cylindrical filter medium through which the water passes into a central, cylindrical shaft-like aperture 118 and upward into the output port 110. The input water moves through the first cylindrical filtration module and second cylindrical filtration module in response to a pressure gradient across the input port 108 and output port 110 provided by the pressurized water source and lower-pressure internal water-supply pipes within a commercial building or residence that receives water filtered by the multiple-filter-media canister-style water filter.

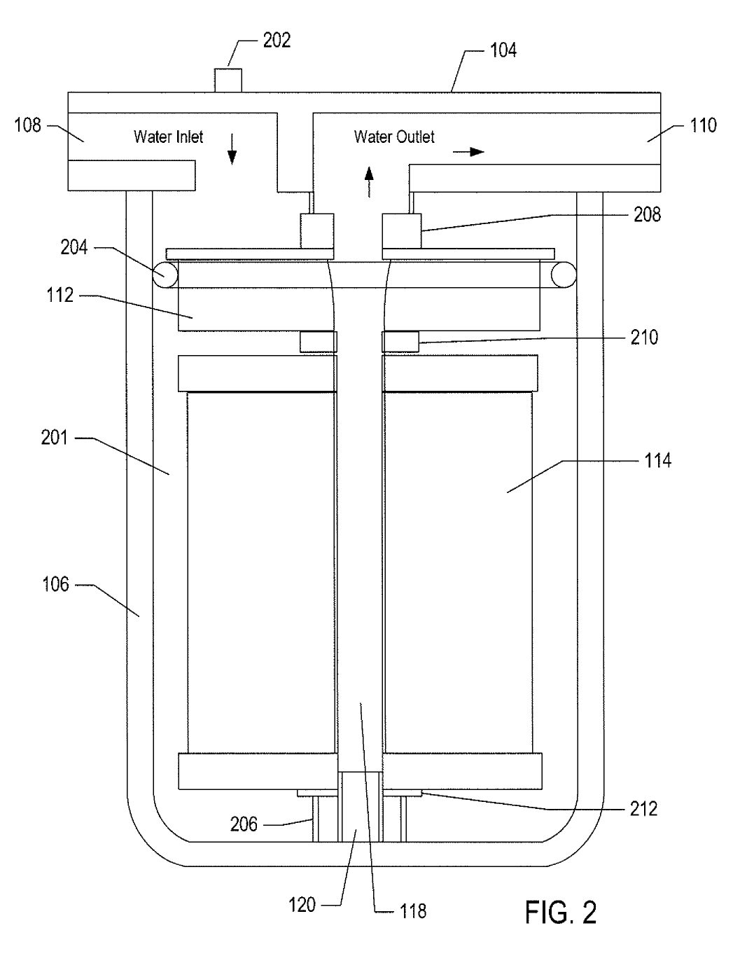

FIG. 2 shows the example multi-figure-media canister-style water filter shown in FIG. 1 in cross-section. For economy and conciseness, features in FIG. 1 labeled with numerical labels are provided the same numerical labels in FIG. 2. The positions of the first filtration module 112 and the second filtration module 114 within the multiple-filter-media canister-style water filter are better illustrated in FIG. 2, and the cylindrical space 201 between the canister housing 106 and second filtration module 114 is also clearly visible. FIG. 2 also shows a pressure-release button 202 extending outward from the end piece 104 that is used to release pressure within the canister prior to unscrewing the canister housing from head unit. FIG. 2 also shows numerous O-rings 204, 208, 210, and 212 that are used to provide a watertight seal for the central, cylindrical shaft-like aperture 118 leading from the interior of the second filtration module 114 to the output port 110. There is, additionally, a filter base 206 shown in FIG. 2 that supports the first-filtration-module and second-filtration-module assembly within the multiple-filter-media canister-style water filter.

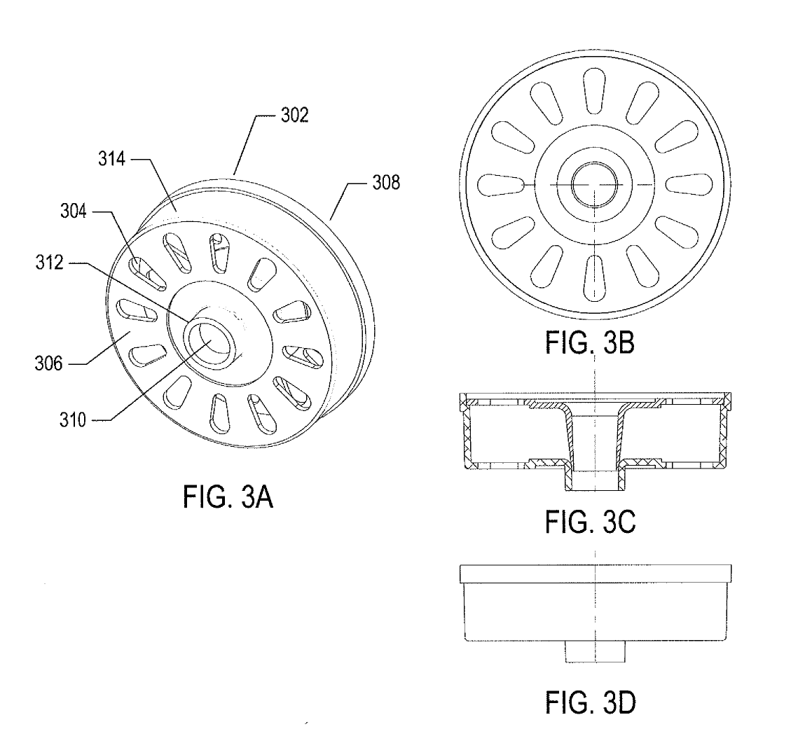

FIG. 3 shows the first internal filtration module of an example multi-filter-media canister-type water filter to which the current application is directed. The first filtration-module housing 302 is a two-part plastic cylinder with radially aligned openings, such as opening 304, in both the bottom, disk-like face 306 and top, disk-like face 308 of the first filtration-module housing. Water passes, under pressure, through the radial openings of the top face into a filter medium enclosed within the first filtration module and out through the radial openings in the bottom phase into the cylindrical space within the canister housing (106 in FIG. 1). The filtration module also includes a central cylindrical aperture 310 that forms a portion of the central cylindrical aperture 118 of the canister-type water filter through which filtered water flows upward and out through the output port. A gasket or O-ring (210 in FIG. 2) fits over a protruding portion of the first filtration-module housing that protrudes from the bottom face 312 and to an annular well on the top face of the first filtration-module housing to seal the cylindrical aperture 310 and prevent flow of untreated or partially treated water into the central cylindrical aperture 118. A large O-ring slides (204 in FIG. 2) over the first filtration-module housing onto the cylindrical side 314 of the first filtration-module housing to provide a tight waterproof seal to prevent untreated water from flowing along the sides of the canister housing 106 past the first-filtration module. FIGS. 3B-D provide top-down and side views of the first-filter housing.

In certain examples of the currently disclosed multi-filter-media canister-style water filter, the first filtration module is loaded with a cylindrical three-dimensional (“3D”) network-material-based filter medium. The 3D-network-material-based medium may include activated carbon, a copper-zinc medium, metal oxides, silver, and resins. The 3D -network-material-based filtration medium is robust, does not need backwashing for periodic cleansing, and provides many more times greater surface area than a comparable amount of granular activated carbon filter medium. The 3D-network-material-based filter medium, when impregnated with activated carbon, effectively removes various types of organic-compound contaminants, some particulates, and other types of contaminants. The 3D-network-material-based filter medium is formed by a process that cross-links or interlaces powdered materials to increase their surface area and enhance their adsorption capacity. In one example, the 3D-network-material-based filter medium is impregnated with a kinetic degradation fluxion (“KDF”) high-purity copper-zinc filter medium. The KDF copper-zinc medium is a redox-type media that is effective in removing metal ions from water as well as chlorine and other contaminants, and has significant anti-microbial properties. Initial filtering of untreated water by this material prolongs the life of, and increases the effectiveness of; the filter medium contained in the second internal module, discussed below.

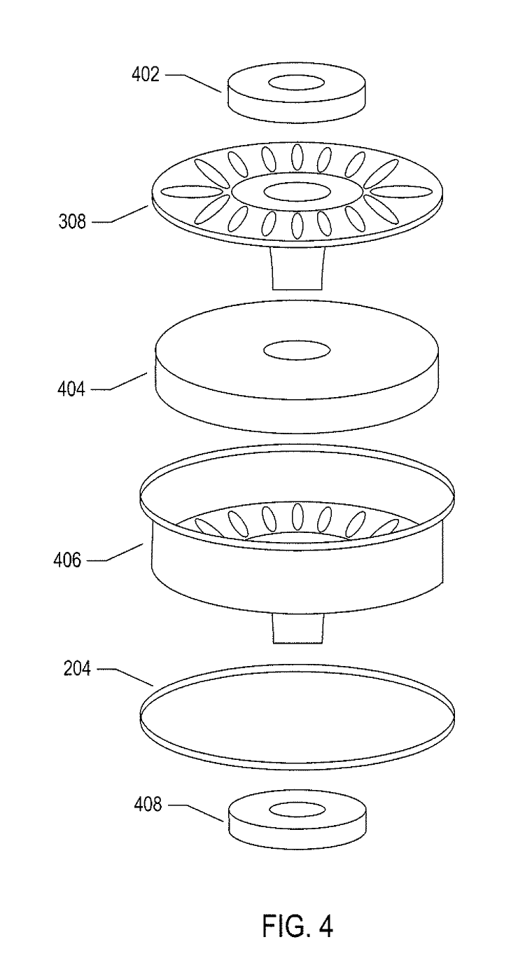

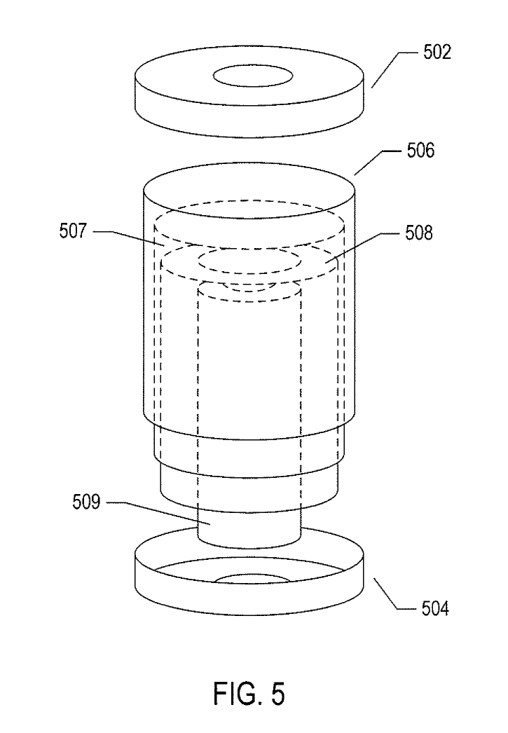

FIG. 4 provides an exploded view of the first internal filtration module shown in FIG. 3. The first internal filtration module is shown, in FIG. 4, to include a top O-ring 402, the top face 308, a cylindrical, disk-like 3D-network-material-based filter medium 404, the remaining portion of the first-filtration-module housing 406, the O-ring (204 in FIG. 2) that fits over the first-filtration-module housing, and a bottom O-ring 408 (210 in FIG. 2). The second internal filtration module (114 in FIG. 1) contains a carbon-block-based filter medium. FIG. 5 illustrates an exploded view of the second internal filtration module of an example multi-filter-media canister-type water filter to which the current application is directed. The second internal filtration module is also cylindrical in shape, comprising a top plastic cap 502 and a bottom plastic cap 504 with a number of nested cylindrical components 506, 507, 508, and 509. The outer cylindrical component 506 is a cylindrical piece of plastic or nylon webbing with large, regularly arranged openings of between two and five millimeters in diameter. A next cylindrical component 507 that fits snuggly inside of the first cylindrical component is a thin cylindrical plastic mesh with much smaller openings. The third cylindrical component 508 nested within the second cylindrical component 507 is a cylindrical carbon-block-based filter medium. A polymeric, porous filter element 509 is nested within the carbon-block-based filter medium 508. The inner polymeric filter element 509 is effective in removing fine particulate contaminants.

The two internal filtration modules (112 and 114 in FIG. 2) fit snuggly together to form the internal, central aperture 118 through which treated water must pass through both filtration modules flows from the second filtration module and upward to the output port (110 in FIG. 1). This central internal aperture is closed by a rubber or polymeric plug (120 in FIG. 1). The two filtration modules can be easily separated and removed, allowing the two different filter media to be independently replaced. As discussed above, use of two different filter media provides for more effective contaminant removal over a broader range of types of contaminants than the use of a single type of filter media. Backwashing and other types of more complex maintenance operations are not needed.

Although the present invention has been described in terms of particular embodiments, it is not intended that the invention be limited to these embodiments. Modifications within the spirit of the invention will be apparent to those skilled in the art. For example, as discussed above, various different types of filter media may be included in the internal modules within the multi-filter-media canister-type water filters to which the current application is directed. In certain examples, additional internal filtration modules may be employed. Material compositions, dimensions, and other characteristics of the components described above may vary in alternative examples of the multi-filter-media canister-type water filter.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A multi-filter-media canister-type water filter comprising:
a canister having
a head unit with a threaded receptacle, input port, and output port, and
a threaded canister housing that screws into the head unit to form a water-tight space within the canister;
a first filtration module that contains a first filtration medium; and
a second filtration module that contains a second filtration medium.

2. The multi-filter-media canister-type water filter of claim I wherein the first filtration module is a cylindrical enclosure with an O-ring that fits within the canister housing to force water from the input port through the first filtration module.

3. The multi-filter-media canister-type water filter of claim 2 wherein the first filtration module includes a central cylindrical aperture that forms a portion of a central cylindrical aperture within the multi-filter-media canister-type water filter leading from an interior of the second filtration module to the output port.

4. The multi-filter-media canister-type water filter of claim 1 wherein the first filtration module is loaded with a KDF filter medium.

5. The multi-filter-media canister-type water filter of claim 1 wherein the second filtration module comprises a cylindrical set of nested cylindrical components held together between a top disk-shaped cap and a bottom disk-shaped cap.

6. The multi-filter-media canister-type water filter of claim 5 wherein the set of nested cylindrical components includes:
a first, outer cylindrical net-like component;
a second, cylindrical mesh component that fits snugly within the outer cylindrical net-like component;
a third, cylindrical 3D-network-material-based filter medium that fits snugly within the second, cylindrical mesh; and
a fourth, polymeric filter that fits snugly within the third, cylindrical 3D-network-material-based filter medium, the fourth, polymeric filter having an inner, cylindrical aperture that forms a portion of a central cylindrical aperture within the multi-filter-media canister-type water filter leading from the inner, cylindrical aperture to the output port.

7. The multi-filter-media canister-type water filter of claim 6 wherein the third, cylindrical 3D-network-material-based filter medium is impregnated with activated carbon.
